(19) United States
(12) Patent Application Publication
(10) Pub. No.: US 2020/0324618 A1
(43) Pub. Date: Oct. 15, 2020

(54) NOISE ATTENUATION DOUBLE WALLS FOR HVAC RECIRCULATION NOISE REFLECTING OFF WINDSHIELD

(71) Applicant: Hanon Systems, Daejeon (KR)

(72) Inventors: David W. Lumley, Livonia, MI (US); Alfonso Pineda Castro, Birmingham, MI (US)

(21) Appl. No.: 16/381,190

(22) Filed: Apr. 11, 2019

(51) Int. Cl. B60H 1/00

(52) U.S. Cl. CPC B60H 1/00564; B60H 2001/006

(57) ABSTRACT

A noise attenuation structure of a housing of a heating, ventilating, and air conditioning system of a vehicle includes a double wall structure. The double wall structure is configured to extend outwardly from an outer surface of the housing to a noise path of the heating, ventilating, and air conditioning system. The double wall structure has a first wall and a second wall spaced from the first wall.

### FIELD OF INVENTION

This disclosure relates generally to minimizing noise in a heating, ventilation, and air conditioning (HVAC) system of a vehicle and more specifically to a double wall structure of a housing of the HVAC system.

### BACKGROUND

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilation and air conditioning (HVAC) system. The HVAC system conditions air flowing therethrough and distributes the conditioned air throughout the passenger compartment.

The HVAC system commonly employs a housing including a blower and one or more heating and cooling devices such as heat exchangers and rotating doors. The blower receives air from an environment outside of the vehicle in a fresh air operating mode of the vehicle and air from inside the vehicle in a recirculation operating mode of the vehicle. Undesirable noise from the HVAC system may be generated and directed towards a passenger compartment of the vehicle. Particularly, the noise may be generated by the blower during the recirculation operating mode of the vehicle.

In certain applications, the HVAC system is disposed towards a front of the vehicle. A spacing for receiving the HVAC system and arrangement of the HVAC system with respect to other devices and structures of the vehicle may be limited based on the functional and packaging requirements of the vehicle. As a result of the limited spacing and arrangement of the HVAC system and package requirements, options for modifying an arrangement of the HVAC system or adjacent components of the vehicle to minimize the noise in a cost effective manner are limited.

In an example according to prior art, as shown in FIG. 1, an HVAC system 100 is disposed in a front portion 102 of a vehicle 104 intermediate the passenger compartment 118 and a front 120 of the vehicle 104. Particularly, the HVAC system 100 may be disposed beneath a top shelf of an instrument panel of the vehicle 104. A blower is disposed in a housing of the HVAC system 100. The housing defines a chamber for conveying air therethrough. During a recirculation mode of the vehicle 104, the blower receives air from inside the vehicle 104 through openings formed in the housing and conveys the air from the inside of the vehicle 104 through the HVAC system 100. The air is then directed towards conduits for delivering the air to areas of the vehicle 104 such as the passenger compartment 118 or a windshield 122, for example. As a result, noise generated by the blower, which can be magnified by turbulent air flow and air flaps or air doors in the HVAC system 100, travels in a direction from the blower, through the openings formed in the housing, to an area or gap formed outside of the housing. The area is intermediate the top shelf of the instrument panel, the openings of the housing, and a connector connecting a portion of the housing and a portion of the top shelf of the instrument panel. From the area, the noise then travels in the direction from the area to the windshield 122, past the top shelf of the instrument panel, and towards the passenger compartment 118.

Therefore, it is desired to provide a double wall structure within a direction of noise traveling from an HVAC system to a passenger compartment of the vehicle, wherein the double wall structure minimizes the noise traveling from the HVAC system and minimizes a compromise to vehicle package requirements and cost efficiency.

### SUMMARY

In accordance and attuned with the present invention, a double wall structure provided within a direction of noise traveling from an HVAC system to a passenger compartment of the vehicle, wherein the double wall structure minimizes the noise traveling from the HVAC system and minimizes a compromise to vehicle package requirements and cost efficiency has surprisingly been discovered.

According to an embodiment of the disclosure, a noise attenuation structure of a housing of a heating, ventilating, and air conditioning system of a vehicle includes a double wall structure is disclosed. The double wall structure is configured to extend outwardly from an outer surface of the housing to a noise path of the heating, ventilating, and air conditioning system. The double wall structure has a first wall and a second wall spaced from the first wall.

According to another embodiment of the disclosure, a heating, ventilating, and air conditioning system of a vehicle includes a blower and an air inlet housing defining a chamber in communication with the blower. A noise attenuation structure is disposed on an outer surface of the air inlet housing. The noise attenuation structure includes a first wall and a second wall spaced from the first wall.

According to yet another embodiment of the disclosure, a heating, ventilating, and air conditioning system and a instrument panel assembly of a vehicle is disclosed. The assembly includes a top shelf of the instrument panel and an air inlet housing of the heating, ventilating, and air conditioning system disposed under the top shelf. An outer surface of the air inlet housing is spaced from the top shelf to form a gap therebetween. A noise path conveys noise therethrough. The noise path extends through the air inlet housing and through the gap. A noise attenuation structure is disposed in the noise path in the gap. The noise attenuation structure includes a first wall and a second wall.

### BRIEF DESCRIPTION OF THE DRAWINGS

The above objects and advantages of the invention, as well as others, will become readily apparent to those skilled in the art from reading the following detailed description of an embodiment of the invention when considered in the light of the accompanying drawings, in which:

FIG. 1 is an enlarged schematic illustration of a heating, ventilating, and air conditioning (HVAC) system positioned in a vehicle according to prior art;

FIG. 2 is a fragmentary cross-sectional elevational view of an HVAC system positioned in a vehicle according to an embodiment of the present invention, wherein the cross-section is taken through a blower air inlet assembly of the HVAC system;

FIG. 3 is a top perspective view of an air inlet housing of the blower air inlet assembly of the HVAC system of FIG. 3 including a noise attenuation structure; and

FIG. 4 is a top perspective view of a portion of an air inlet housing of a blower air inlet assembly of an HVAC system including a noise attenuation structure according to another embodiment of the invention.

### DETAILED DESCRIPTION OF THE EMBODIMENTS

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical unless otherwise noted.

A” and “an” as used herein indicate “at least one” of the item is present; a plurality of such items may be present, when possible. As used herein, “substantially” means “to a considerable degree,” “largely,” or “proximately” as a person skilled in the art in view of the instant disclosure would understand the term. Spatially relative terms, such as “front,” “back,” “inner,” “outer,” “bottom,” “top,” “horizontal,” “vertical,” “upper,” “lower,” “side,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

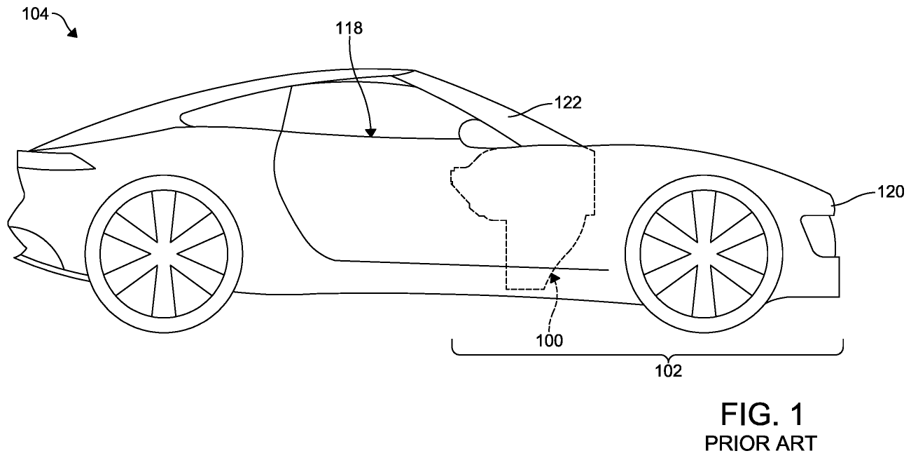

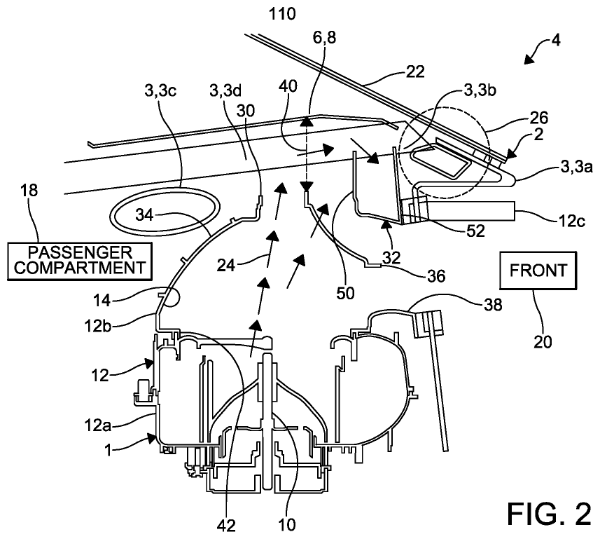

FIG. 2 illustrates a heating, ventilating, and air conditioning (HVAC) system 1 according to an embodiment of the instant disclosure. Similar to FIG. 1, the HVAC system 1 is disposed in a front portion 2 of a vehicle 4 intermediate a passenger compartment 18 and a front 20 of the vehicle 4. The HVAC system 1 is disposed beneath a top shelf 8 of an instrument panel 6 of the vehicle 4 which is disposed beneath a front windshield 22 of the vehicle 4. Other framework, paneling, or components 3 of the vehicle 4 or HVAC system 1 are disposed adjacent and about the HVAC system 1 to support the HVAC system 1 or other components of the vehicle 4. For example, as shown, a connector 3a joining portions of the instrument panel 6 and the HVAC system 1, conduits 3c of the HVAC system 1 or the vehicle 4, a noise barrier 3d formed from a foam material are shown as some of the components 3 of the vehicle 4. The noise barrier 3d is disposed under the top shelf 8 of the instrument panel 6 and is configured to attenuate noises traveling therethrough. The conduits 3c can be air ducts for conveying air to the windshield 22 or the passenger compartment 18 of the vehicle 4, for example. It is understood, the HVAC system 1 can be disposed in other positions and locations of the vehicle 4, if desired.

The HVAC system 1 includes a housing 12 defining a chamber 14 for conveying air therethrough. In the cross-section illustrated, the housing 12 is a blower inlet housing assembly forming a portion of the HVAC system 1 of the vehicle 4. The housing 12 includes a blower housing 12a receiving a blower 10, an air inlet housing 12b, and a fresh air housing 12c. The blower 10 receives the air from the air inlet housing 12b from either the passenger compartment or the environment and conveys the air through the HVAC system 1. The HVAC system 1 operates between a fresh air operating mode and recirculation operating mode. During the fresh air operating mode, fresh air from the environment flows through the fresh air housing 12c to the air inlet housing 12b and from the air inlet housing 12b to the blower 10. During the recirculation mode, recirculated air from the passenger compartment 18 flows through a recirculated air opening 30 to the air inlet housing 12b and from the air inlet housing 12b to the blower 10. The air received by the blower 10 from the passenger compartment 18 of the vehicle 4 or the environment is then distributed through the HVAC system 1 to the conduits 3c such as air ducts to areas of the vehicle 4 such as the passenger compartment 18 or the windshield 22.

The air inlet housing 12b includes a door 36 disposed therein. The door 36 selectively rotates between a first position and a second position. In the first position, the door 36 closes the recirculated air opening 30 to prevent the recirculated air from being received into the air inlet housing 12b. In the second position, the door 36 closes a fresh air opening 38 to prevent the fresh air from being received into the air inlet housing 12b. As illustrated, the door 36 is in an intermediate position between the first position and the second position.

While not shown, it is understood the housing 12 is coupled to or integrally formed with other housings of the HVAC system 1 such as a main housing fluidly connecting the housing 12 to the conduits 3c. Additionally, while not shown, the HVAC system 1 can include other devices or components commonly included in HVAC systems such as heat exchangers, valves, alternate doors or flaps, walls, partitions, or similar components.

A noise attenuation structure 32 is disposed in a noise path of noise 24. The noise attenuation structure 32 is configured as a double wall structure extends outwardly from an outer surface 34 of the air inlet housing 12b. The noise attenuation structure 32 extends into a gap 40 formed intermediate the top shelf 8 of the instrument panel 6 and the outer surface 34 of the air inlet housing 12b. The noise attenuation structure 32 is formed adjacent an area 26 (generally defined by the circle) including the connector 3a disposed beneath a portion of the windshield 22 and the top shelf 8 of the instrument panel 6.

During the recirculation operating mode, the blower 10 generates the noise 24 that travels in the noise path in a direction indicated by the solid arrow. As used herein, the term “noise” refers to a sound or sounds generated by operation of the vehicle 4 such as operation of the blower 10, turbulent air flow through the housing 12 of the HVAC system 1, or operation of other components of the HVAC system 1. The noise 24 is typically undesired by passengers in the passenger compartment 18. The noise 24 travels from the blower 10 to the gap 40 and to the noise attenuation structure 32. The noise 24 is attenuated and dissipated by the noise attenuation structure 32. The noise 40 is militated from traveling beyond the noise attenuation structure 32 to the area 26 or beyond the area 26 to the windshield 22 and, ultimately, the passenger compartment 18.

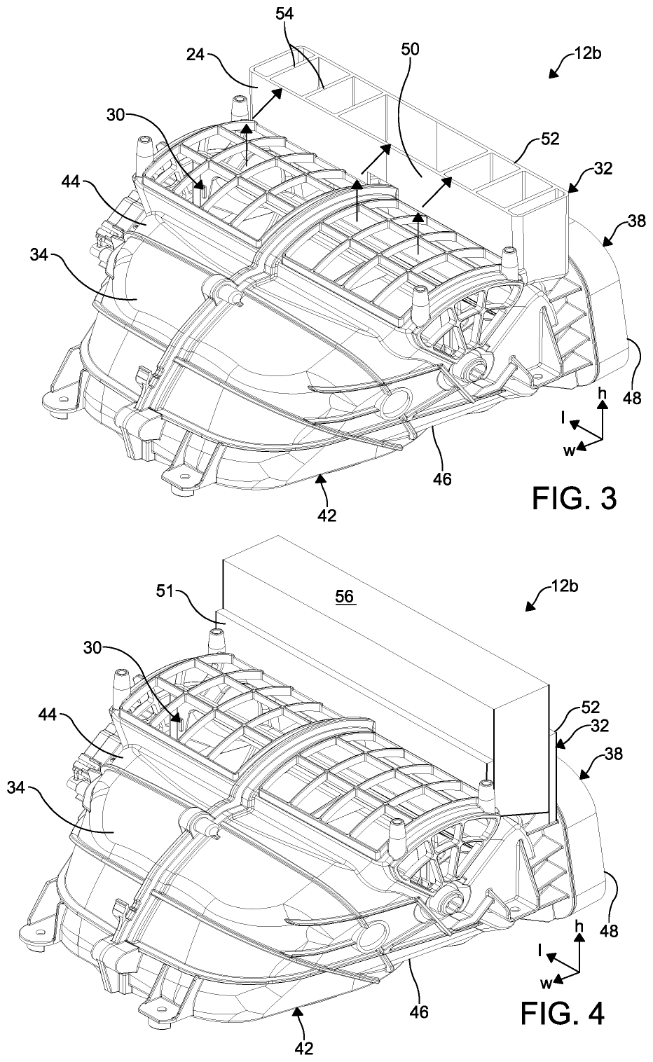

FIG. 3 illustrates the inlet housing 12b including the recirculated air opening 30, a fresh air opening 38 for receiving the fresh air from the fresh air housing 12c, and a blower opening 42 for conveying the fresh air or the recirculated air to the blower housing 12a. As shown, the recirculated air opening 30 is formed in an upper wall 44 of the air inlet housing 12b and opposes the blower opening 42 formed in a lower wall 46 of the air inlet housing 12b. The fresh air opening 38 is formed in a side wall 48 of the air inlet housing 12b in a position substantially normal to the recirculated air opening 30 and the blower opening 42. However, it is understood the recirculated air opening 30, the fresh air opening 38, and the blower opening 42 can be formed in any arrangement with respect to each outer and with respect to the air inlet housing 12b as desired depending on vehicle package requirements.

The noise attenuation structure 32 extends outwardly from the outer surface 34 of the upper wall 44 of the air inlet housing 12b and is disposed intermediate the recirculated air opening 30 and the fresh air opening 38. The noise attenuation structure 32 includes a first wall 50 and a second wall 52 spaced from the first wall 50. The walls 50, 52 extend substantially along an entire length of the air inlet housing 12b and are substantially equal in length. However, it is understood, the walls 50, 52 can extend less than or greater than the length of the air inlet housing 12b, if desired. Additionally, the walls 50, 52 can extend at unequal lengths from each other.

Referring to FIG. 2, a height of the walls 50, 52 is less than a distance of the gap 40 formed intermediate the outer surface 34 of the air inlet housing 12b and the top shelf 8 of the instrument panel 6. Where the vehicle 4 includes the noise barrier 3d, the walls 50, 52 extend to or partially into the noise barrier 3d, wherein the height of the walls 50, 52 is slightly greater than a distance between the outer surface 34 of the air inlet housing 12c and the noise barrier 3d. In the embodiment illustrated, the noise barrier 3d extends in a width direction over the noise attenuation structure 32 and into the area 26. However, in other embodiments, where the noise barrier 3d is absent, the height of the walls 50, 52 may be substantially equal to or slightly less than the gap 40. The noise barrier 3d is configured to facilitate attenuation of the noise 24 traveling therethrough. It is understood, the walls 50, 52 can have equal or unequal heights with respect to each other, if desired, depending on a surface contour of the upper wall 44 or to avoid obstruction to the components 3 of the vehicle 4. As illustrated, a height direction of the air inlet housing 12b is represented by “h”, a length direction of the air inlet housing 12b is represented by “l”, and a width direction of the air inlet housing 12b is represented by “w.”

With renewed reference to FIG. 3, the noise attenuation structure 32 includes a plurality of ribs 54 extending between the first wall 50 and the second wall 52. The ribs 54 are configured to support and facilitate stability and rigidity of the walls 50, 52. The ribs 54 also provide edges for attachment to other components such as the noise barrier 3d, for example. In the embodiment illustrated, eight ribs 54 are shown. However, more than or fewer than eight of the ribs 54 may extend between the walls 50, 52.

The noise attenuation structure 32 is formed by a plastic material by a molding process. However, the noise attenuation structure 32 can be formed by any process from any material, as desired. The noise attenuation structure 32 is integrally formed with the air inlet housing 12b. However, it is understood, the noise attenuation structure 32 can be separately formed from the air inlet housing 12b and coupled thereto.

During operation of the vehicle 4, particularly during the recirculation operating mode, the noise 24 travels in the noise path from the blower 10, through the air inlet housing 12b, outwardly from the air inlet housing 12b through the recirculated air opening 30, and to the gap 40. Since the noise attention structure 32 is disposed in the noise path, a first portion of the noise 24 traveling through the noise path is dissipated by the first wall 50. A second portion of the noise 24 not entirely dissipated by the first wall 50 continues to travel beyond the first wall 50 and is then dissipated by the second wall 52. As a result, the noise 24 is prevented from traveling beyond the noise attenuation structure 32 to the area 26 and the windshield 22 and from the windshield 22 to the passenger compartment 18. Therefore, a comfort within the passenger compartment 18 related to noise tolerance is not compromised.

FIG. 4 illustrates a noise attenuation structure 32′ of the air inlet housing 12b according to another embodiment of the disclosure. Features of the noise attenuation structure 32′ of FIG. 4 similar to the noise attenuation structure 32 of FIGS. 2-3 are indicated by the same reference numeral but with a prime (′) symbol for convenience. The noise attenuation structure 32′ of FIG. 4 is similar to the noise attenuation structure 32 of FIGS. 2-3, except the noise attenuation structure 32′ of FIG. 4 includes a noise barrier 56 disposed between the first wall 50 and the second wall 52.

The noise barrier 56 is formed from a noise absorbing acoustic foam material, for example. However, the noise barrier 56 can be formed from wool, fiberglass, vinyl, plastic, glass or any other noise absorbing, dampening, attenuating, or insulating material as desired. The noise barrier 56 is positioned intermediate the first wall 50′ and the second wall 52′. The noise barrier 56 has a width equal to a distance between the walls 50′, 52′. However, the noise barrier 56 may have a width less than the distance between the walls 50′, 52′, if desired. A height of the noise barrier 56 is greater than the height of the walls 50′, 52′ to minimize the noise 24 traveling the noise path above the walls 50′, 52′. However, it is understood, the height of the walls 50′, 52′ can be less than or equal to the height of the walls 50′, 52′. In the embodiment illustrated, the ribs 54 are not included between the first wall 50′ and the second wall 52′ to accommodate the noise barrier 56. The noise barrier 56, therefore, provides support and rigidity to the walls 50′, 52′ by minimizing a bending of the walls 50′, 52′. As illustrated, a single one of the noise barrier 56 is shown. However, the noise barrier 56 can be a plurality of layered, stacked, or piled noise attenuating materials.

It is understood, the noise attenuation structure 32, 32′ can be positioned in alternate arrangements with respect to the air inlet housing 12b without departing from the scope of the disclosure depending on the location of the noise path. Additionally, more than one noise attenuation structure 32, 32′ can extend from the air inlet housing 12b, if desired, to militate the noise 24 traveling through the noise path or to militate against other noises traveling through alternate noise paths.

Advantageously, the noise 24 traveling through the HVAC system 1 to the passenger compartment 18 is reduced by the noise attenuation structure 32, 32′. In addition to the walls 50, 50′, 52, 52′, a space formed between the first wall 50, 50′ and the second wall 52, 52′ is configured as a noise isolating air space configured to further facilitate attenuation of the noise 24 traveling through the noise path to the windshield 22 and reflecting off the windshield 22 to the passenger compartment 18.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A noise attenuation structure of a housing of a heating, ventilating, and air conditioning system of a vehicle comprising:
a double wall structure configured to extend outwardly from an outer surface of the housing to a noise path of the heating, ventilating, and air conditioning system, the double wall structure having a first wall and a second wall spaced from the first wall.

2. The noise attenuation structure of claim 1, wherein a noise barrier is disposed between the first wall and the second wall.

3. The noise attenuation structure of claim 2, wherein the noise barrier is formed from an acoustic foam.

4. The noise attenuation structure of claim 1, wherein a plurality of ribs extends between the first wall and the second wall.

5. The noise attenuation structure of claim 1, wherein a length of each of the first wall and the second wall is substantially equal to a length of the housing.

6. The noise attenuation structure of claim 1, wherein the noise attenuation structure is one of integrally formed with and separately formed from the housing.

7. A heating, ventilating, and air conditioning system of a vehicle comprising:
a blower;
an air inlet housing defining a chamber in communication with the blower; and
a noise attenuation structure disposed on an outer surface of the air inlet housing, the noise attenuation structure including a first wall and a second wall spaced from the first wall.

8. The heating, ventilating, and air conditioning system of claim 7, wherein the air inlet housing includes a recirculated air opening configured to receive recirculated air from a passenger compartment of the vehicle and a fresh air opening configured to receive fresh air from the environment, wherein the noise attenuation structure is disposed intermediate the recirculated air opening and the fresh air opening.

9. The heating, ventilating, and air conditioning system of claim 8, wherein a noise generated by the blower flows through a noise path, the noise path extending from the blower to the chamber of the air inlet housing and from the chamber of the air inlet housing to an exterior of the air inlet housing, and wherein the noise attenuation device is disposed in the noise path.

10. The heating, ventilating, and air conditioning system of claim 7, wherein a rib extends between the first wall and the second wall.

11. The heating, ventilating, and air conditioning system of claim 7, wherein a noise barrier is disposed between the first wall and the second wall.

12. The heating, ventilating, and air conditioning system of claim 7, wherein a length of each of the first wall and the second wall is substantially equal to a length of the air inlet housing.

13. The heating, ventilating, and air conditioning system of claim 7, wherein the noise attenuation device is one of integrally formed with or separately formed from the air inlet housing.

14. A heating, ventilating, and air conditioning system and an instrument panel assembly of a vehicle comprising:
a top shelf of the instrument panel;
an air inlet housing of the heating, ventilating, and air conditioning system disposed under the top shelf, an outer surface of the air inlet housing spaced from the top shelf to form a gap therebetween;
a noise path conveying noise therethrough, the noise path extending through the air inlet housing and through the gap; and
a noise attenuation structure disposed in the noise path in the gap, the noise attenuation structure includes a first wall and a second wall.

15. The assembly of claim 14, wherein a noise barrier is disposed under the top shelf and engages the noise attenuation structure.

16. The assembly of claim 14, wherein a length of each of the first wall and the second wall is substantially equal to a length of the air inlet housing.

17. The assembly of claim 14, wherein the noise attenuation structure extends outwardly from the outer surface of the air inlet housing, and wherein each of the first wall and the second wall have a height one of substantially equal to or less than a height of the gap.

18. The assembly of claim 14, wherein the air attenuation device attenuates noise traveling to an area formed under the top shelf intermediate the noise attenuation device and the windshield.

19. The assembly of claim 14, wherein a plurality of ribs extend between the first wall and the second wall.

20. The assembly of claim 14, wherein a noise barrier is disposed intermediate the first wall and the second wall.
